(19) United States
(12) Patent Application Publication
(10) Pub. No.: US 2006/0085405 A1
(43) Pub. Date: Apr. 20, 2006

(54) Method for analyzing and classifying electronic document

(76) Inventors: Fu-Chiang Hsu, Hsinchu City (TW); Jiang-Liang Hou, Hsinchu City (TW); Pei-Hsun Ho, Hsinchu City (TW); Amy J.C. Trappey, Hsinchu City (TW); Charles V. Trappey, Hsinchu City (TW); Shang-Jyh Liu, Hsinchu City (TW)

Correspondence Address: J C PATENTS, INC., 4 VENTURE, SUITE 250, IRVINE, CA, 92618, US

(21) Appl. No.: 11/049,792

(22) Filed: Feb. 2, 2005

(30) Foreign Application Priority Data
Oct. 18, 2004 (TW) 93131521

(51) Int. Cl. G06F 17/30

(52) U.S. Cl. 707/3

(57) ABSTRACT

A method for analyzing and classifying electronic documents. The method comprises steps of fetching an electronic document from an electronic document folder, wherein the electronic document comprises a plurality of key words. Then, the key words are retrieved. Further, according to an appearance frequency of each key word, a correlation between each two key words is calculated. Further, according to the correlations between the key words, the key words are classified into at least one technology group. Finally, the documents in the document folder are classified into at least one document group.

### CROSS-REFERENCE TO RELATED APPLICATION

This application claims the priority benefit of Taiwan application Ser. No. 93131521, filed on Oct. 18, 2004.

### BACKGROUND OF THE INVENTION

1. Field of Invention

The present invention relates to a method for analyzing documents. More particularly, the present invention relates to a method for analyzing and classifying electronic documents.

2. Description of Related Art

In the highly competitive industrial environment, in order to increase and to maintain the research potential, every business party not only physically invest money on researching projects but also improve the value of the invisible property such as knowledge documents, patents, trademarks and copyrights. Therefore, the business parties start to take the information management about the knowledge related to the business management seriously. Moreover, because of the highly development of the information technology and the network transmission technology, the barrier of time and space for accessing the knowledge and the information can be broken down through using electronic technology. Hence, any kind of information can be obtained rapidly. Therefore, these electronic documents easily to be managed, transmitted or stored gradually replace the conventional document storage media such as books or paper.

The primary object for the knowledge document is to transmit information. Hence, the knowledge document should possesse a structure property for the reader to easily understand the document. The primary object for the management of the electronic document is to understand the basic data definition for later analyzing process. The fist step of managing electronic documents is to differentiate the type of the documents. Tyrvaninen et al. provide a electronic document management system to analyze and to classify the business inner documents (Tyrvainen and Paivarinta, 1999).

FIG. 1 is a flow chart showing a conventional method for analyzing documents. As shown in FIG. 1, the conventional method for analyzing documents is document classification. In the document classification, the documents obtained by recording or storing are fetched form the document folder (step S101). Then, in the step S103, the categories of the documents are previously defined so as to store and manage the mass of the documents according to the classification, wherein the category of the documents is denominated according to key technologies in the documents. Thereafter, in the step S105, by using the categories defined in step S103, the documents fetched in step S101 are compared with the document categories individually basing on the vocabularies, contents, characteristics or other properties. According to the similarities between the documents and the categories, the documents are classified into different classes to finish the classification (step S107).

Altogether, in the conventional analyzing method, it is necessary to define the document categories previously and it cannot be sure whether the definition completely meets the classification requirements. Further, it also cannot be sure how detail the categories should be or even it is not necessary to define some specific categories. Moreover, for some categories, the technology contents of some documents are quite different from each other after the classification so that the document classification fails to obtain the features of referring to and fully understanding the technologies basing on the least documents easily. Additionally, in the document classification, sometimes the personal subjective factors will influence the result of the classification and there are no identical and serious standards so that the great classification divergence will happen during the comparison step.

### SUMMARY OF THE INVENTION

Accordingly, at least one objective of the present invention is to provide a method for analyzing and classifying electronic documents capable of defining document groups basing on the technology group obtained by analyzing the key words in the documents. Therefore, the usage frequency of each document group is increased.

At least a second objective of the present invention is to provide a method for analyzing and classifying electronic documents capable of grouping mass of documents under no pre-classification situation. Hence, when the user searches documents about certain technology, the documents highly related to the technology can be found out and the searching efficient is increased.

The present invention provides a method for analyzing and classifying electronic documents. The method comprises steps of fetching an electronic document from an electronic document folder, wherein the electronic document comprises a plurality of key words. Then, the key words are retrieved. Further, according to an appearance frequency of each key word, a correlation between each two key words is calculated. Finally, according to the correlations between the key words, the key words are classified into at least one technology group.

In the present invention, the step of retrieving the key words include at least one step selected form a group composed of word section analyzing, rhetoric analyzing, vocabulary comparison, word frequency maintaining, retrieving the key word of the candidate word library and retrieving the key word of the word library waiting for confirmation.

Moreover, in the present invention, the step of calculating the correlation between each two key words according to the appearance frequency of each key word comprises steps of de-duplicating the identical key words with merging the appearance frequencies thereof. And then, the correlation of each two key words is calculated.

Furthermore, the former mentioned step of the step of de-duplicating the identical key words with merging the appearance frequencies thereof comprises steps of retrieving the key words from the electronic document. Then, the duplicated key words are merged and the appearance frequencies of the key words are re-calculated.

Additionally, the step of the step of re-calculating the correlation of each two key words comprises steps of obtaining the appearance frequency of each key word and calculating a correlation coefficient between each two key words, wherein the correlation coefficient between each two key word denotes the correlation between the appearance frequencies of the key words.

Also, the step of classifying the key words comprises steps of forming a vocabulary data by using the correlations and a Cartesian dimension system with a dimension corresponding to the number of the key words, wherein each key word is represented by a data point with a coordinate composed by the correlation coefficients. The data points in the vocabulary data are grouped into at least one technology group by using K-Means algorithm.

In the present invention, it further comprises a step of obtaining a maturity of a technology group by using the number of the key words, the number of the electronic documents in the technology group and the number of the key words in the technology group.

The present invention also provide a method for analyzing and classifying electronic documents. The method comprises steps of fetching a plurality of documents from a document folder, wherein at least one of the electronic documents includes at leas a technology group. Then, the technology groups in the electronic documents are obtained and an appearance frequency of each technology group in the electronic documents are statistically calculated. Finally, according to the appearance frequency of each technology group in the electronic documents, the electronic documents are classified into at least one document group.

In the present invention, the step of obtaining the technology groups in the electronic documents comprises steps of retrieving a plurality of key words in the electronic documents and calculating a correlation between each two key words according to an appearance frequency of each key word. Then, the key words are classified into at least one technology group according to the correlations between the key words.

Moreover, the former mentioned step of retrieving the key words include at least one step selected form a group composed of word section analyzing, rhetoric analyzing, vocabulary comparison, word frequency maintaining, retrieving the key word of the candidate word library and retrieving the key word of the word library waiting for confirmation.

Moreover, in the present invention, the step of calculating the correlation between each two key words according to the appearance frequency of each key word comprises steps of de-duplicating the identical key words with merging the appearance frequencies thereof. And then, the correlation of each two key words is calculated.

Furthermore, the former mentioned step of the step of de-duplicating the identical key words with merging the appearance frequencies thereof comprises steps of retrieving the key words from the electronic document. Then, the duplicated key words are merged and the appearance frequencies of the key words are re-calculated.

Additionally, the step of the step of re-calculating the correlation of each two key words comprises steps of obtaining the appearance frequency of each key word and calculating a correlation coefficient between each two key words, wherein the correlation coefficient between each two key word denotes the correlation between the appearance frequencies of the key words.

Also, the step of classifying the key words comprises steps of forming a vocabulary data by using the correlations and a Cartesian dimension system with a dimension corresponding to the number of the key words, wherein each key word is represented by a data point with a coordinate composed by the correlation coefficients. The data points in the vocabulary data are grouped into at least one technology group by using K-Means algorithm.

In the present invention, the step of classifying the electronic documents comprises steps of forming a technology data by using the appearance frequency of each technology group and a Cartesian dimension system with a dimension corresponding to the number of the technology groups, wherein each technology group is represented by a data point with a coordinate composed by the appearance number of each technology group. The data points in the technology data are grouped into at least one document group by using K-Means algorithm.

Altogether, the method for analyzing and classifying electronic documents of the present invention comprises the steps of retrieving the key words in the documents and then statistically calculating and merging the appearance frequencies of the key words. Further, the correlations between key words are established and then the key words are grouped into several technology group mentioned in the electronic documents. Each technology group is the key word included in the technology so that each technology group can be the classification basis for means for performing the classification of the documents and the usage frequency and the detail level of the classification are increased. Moreover, under no pre-classification situation or in the circumstance of further analyzing highly similar documents in the same class, the user can easily use the technology groups and key words to search certain documents and then can also retrieve other documents highly analogue technology content. Accordingly, the accuracy of the automatically analyzing and classifying technology is improved and the searching efficiency is increased.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart showing a conventional method for analyzing documents.

FIG. 2 is a flow chart showing a method of analyzing and classifying the electronic documents according to the preferred embodiment of the present invention.

FIG. 3 is a flow chart illustrating the step S203 shown in FIG. 2.

FIG. 4 is a table showing correlation coefficients of the key words according to the preferred embodiment of the present invention.

FIG. 5 and FIG. 6 are diagrams showing K-Means algorithm of the preferred embodiment of the present invention.

FIG. 7 is a statistic table of the technology groups in the electronic documents according to the preferred embodiment of the present invention.

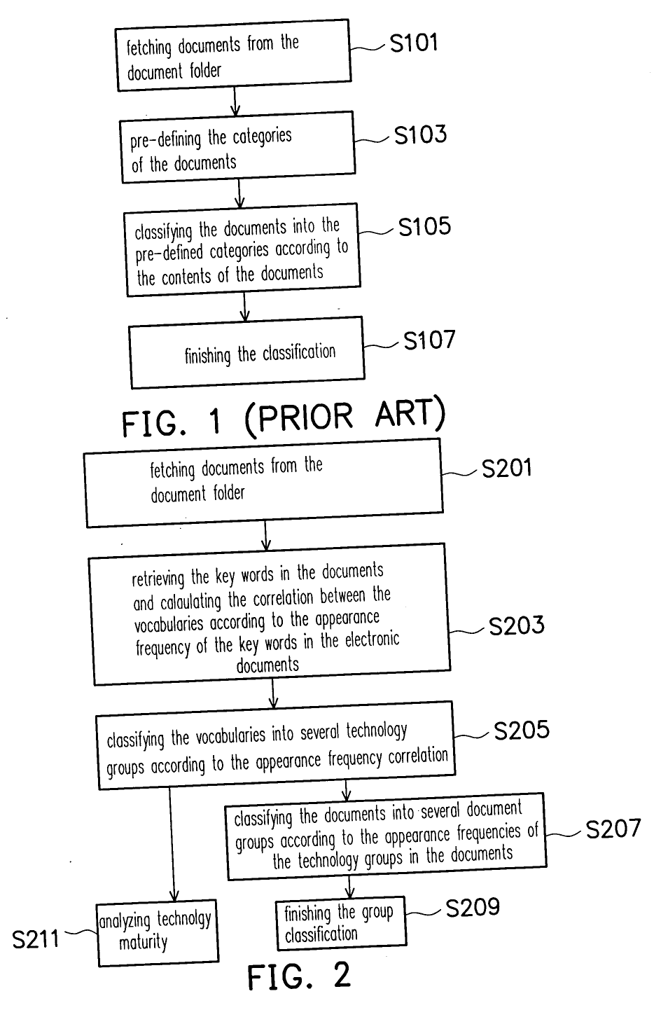

### DESCRIPTION OF THE PREFERRED EMBODIMENTS

In the present invention, the method for analyzing and classifying documents capable of analyzing the technology groups of the documents according to the key words in the documents. Therefore, the means for classifying documents can base on the technology groups to define the categories of the documents so as to increase usage frequency and the detail level of each document category. Moreover, under the premise that no prior classification is made, the mass of documents can be classified by using the method of analyzing and classifying documents. Therefore, when assisting the user to search a specific technology, the method can provide a more efficient searching way to find out the documents related to the specific technology. Hence, the invisible knowledge property in the enterprise can be well and efficiently managed and the user can analyze the known technology by using this method to determine the future research direction.

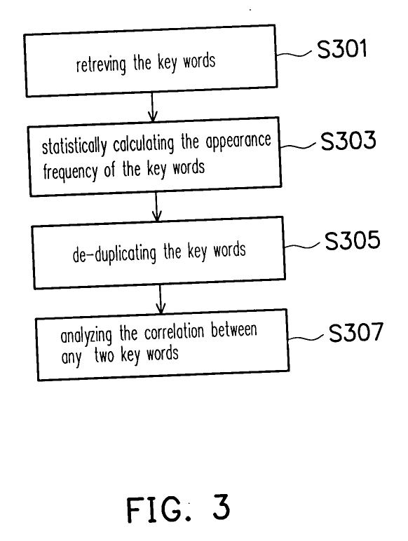

A preferred embodiment is provided to details the present invention. FIG. 2 is a flow chart showing a method of analyzing and classifying the electronic documents according to the preferred embodiment of the present invention. As shown in FIG. 2, in the step S201, documents previously obtained by recording or storing are fetched form the document folder. In the step S203, the key words are retrieved from the obtained documents in the step 201 and the correlation between the vocabularies is calculated according to the appearance frequency of the key words in the documents. In this embodiment, the details of the step S203 can be described by using FIG. 3. FIG. 3 is a flow chart showing the inference method of vocabulary correlation provided by Chiang-Liang Hou and Chuang-En Chan in 2003 capable of inferring “Chinese key words”, “English key words” and “vocabulary correlation array table” according to the content of the document. Referring to FIG. 3 together with FIG. 2, in the step S301, the key words are retrieved from the documents obtained in the step S201, wherein the appearance frequency of a vocabulary in the documents defines whether the vocabulary is a key word or not and then by using the steps of word section analyzing, rhetoric analyzing, vocabulary comparison, word frequency maintenance, retrieving the key word of the candidate word library and retrieving the key word of the word library waiting for confirmation, the key words can be retrieved from the documents in the document folder. After the step S301 in which the key words are retrieved from the documents, in the step S305, a statistic calculation is performed according to the appearance frequency of each key word in each document to establish a statistic table of the appearance frequency of the key words. In the step S305, after the key words are retrieved and the appearance frequencies of the key words are analyzed, a de-duplicate operation is performed to merge the duplicated key words for individual document so as to eliminate excess column. Accordingly, the statistic table of the appearance frequency of the key words is refreshed and adjusted. In the step S307 after the step S305, for any two vocabularies in the statistic table of the appearance frequency of the key words, a correlation coefficient Rᵢⱼ of the key words, Vᵢ, Vⱼ (i≠j), is established. More specifically, the correlation coefficient can be expressed by the following equation:

$${R}_{ij} = \frac{{\sum }_{l = 1}^{{N}_{D}} {X}_{i , l} {X}_{j , l} - {N}_{D} {\overline{X}}_{i} {\overline{X}}_{j}}{\sqrt{( {\sum }_{l = 1}^{{N}_{D}} {X}_{i , l}^{2} - {N}_{D} {\overline{X}}_{i}^{2} ) ( {\sum }_{l = 1}^{{N}_{D}} {X}_{j , l}^{2} - {N}_{D} {\overline{X}}_{j}^{2} )}}$$

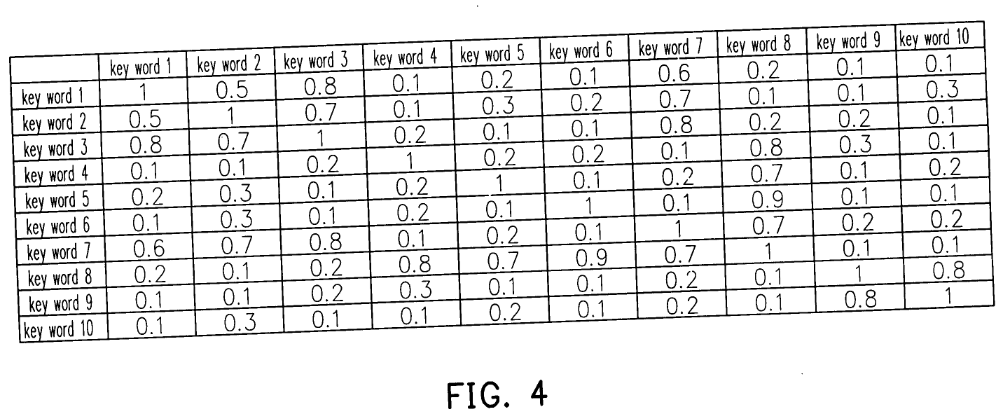

In the above equation, the X_{i,l}, denotes that the appearance number of a key word Vᵢ which has been de-duplicated in a first document Dₗ and the N_{D} denotes the total amount of the documents in the document folder. Therefore, FIG. 4 is obtained. FIG. 4 is a table showing correlation coefficients of the key words according to the preferred embodiment of the present invention. More specifically, the correlation coefficient table of the key words represents the appearance frequency correlation between any two key words showing in the table.

After the correlation coefficient table is established in step S307, the key words are classified into several technology groups by using the correlation coefficient table (step S205). Basing on the correlation coefficient table obtained by the analytic result and the correlation analysis of the historic technology vocabularies, if there are N numbers of key words, each key word can be represented by an N dimension coordinate with N elements in an N dimensional Cartesian coordinate system, wherein each element is the correlation coefficient between the key word and the other key words or itself. More specifically, taking the correlation coefficient table shown in FIG. 4 as an example, there are ten key words and the coordinate of the key word labeled as 1 in the first row comprises ten elements in a ten-dimensional Cartesian coordinate system, wherein each correlation coefficient in the first row respectively represents an element in the coordinate of the key word 1. That is, the first element of the coordinate of the key word 1 is the correlation coefficient between the key word labeled as 1 and itself and the second element of the coordinate of the key word 1 is the correlation coefficient between the key word 1 and the key word 2. Therefore, each key word in a group of N key words can be a data point drawn in an N dimensional Cartesian coordinate system and the coordinate of each key word is used as an input value in vocabulary classification operation. Hence, by using K-Means algorithm, the words with highly similar meanings can be distinguished from each other and are grouped into different technology groups. In K-Means algorithm, it further exists a classification parameter, a seed number. That is, the seed number counts the number of the classification groups. Since there are N numbers of key words, the seed number is counted from 1 to N. That is, the key words can be grouped into 1 to N numbers of groups.

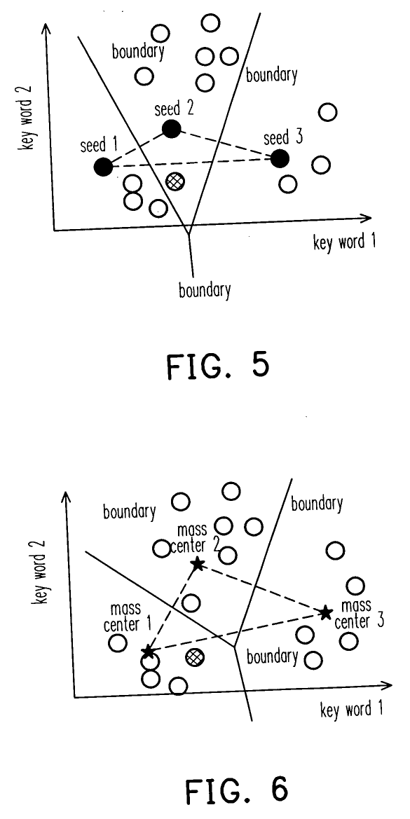

The following is a description of the process of K-Mean algorithm. FIG. 5 and FIG. 6 are diagrams showing K-Means algorithm of the preferred embodiment of the present invention. As shown in FIG. 5, before the steps of the classification of K-Means algorithm in this embodiment is illustrated, it is presumed that the correlation coefficients of key words labeled as 1 and 2 respectively are used to classify N numbers of key words and the seed number is 3. First, since the number of the key words used as classification bases is 2, the correlation coefficients of key word 1 are composed to be the X coordinate axis and the correlation coefficients of key word 2 are composed to be the Y coordinate axis in a two-dimensional Cartesian coordinate system. Also, N numbers of the key words are drawn in the two-dimensional Cartesian coordinate system by using their coordinates. The coordinate points of three key words are randomly selected and are labeled as seed 1, seed 2 and seed 3 respectively. Then, the mass center of the seed 1, the seed 2 and the seed 3 is pointed out in the two-dimensional Cartesian coordinate system. Thereafter, the mass center of the seed 1, the seed 2 and the seed 3 and the extension of the perpendicular bisectors with respect to the connection lines between each two points of the seed 1, the seed 2 and the seed 3 are used to separate the N numbers of the data points representing the N numbers of key words respectively into 3 groups. Referring to FIG. 5 together with FIG. 6, the mass center of each group is obtained and the mass centers are labeled as mass center 1, mass center 2 and mass center 3 respectively. A new mass center can be obtained from the mass center 1, the mass center 2 and the mass center 3. Further, by using the new mass center and the extension of the perpendicular bisectors with respect to the connection lines between each two points of the mess center 1, the mass center 2 and the mass center 3, the N numbers of the data points representing the N numbers of key words respectively are separated into 3 groups. Then, the operations described above are repeated until the coordinates of the three mass centers and the newly obtained mass center from said three mass centers are not changed so as to determine the boundaries between these three groups. The groups with the boundaries obtained by K-Means algorithm are the preferred classification group of the N numbers of the key words. When the seed number is set from 1 to N in K-Means algorithm, the N numbers of the data points representing N numbers of the key words are separated into the one technology group to separated into the N numbers of technology groups and then the quality of the classification is reviewed by examining root-mean-square standard deviation (RMSSTD). of the classification groups and the R-square (RS) of the classification groups.

In order to particularly describe the spirit of the present invention, the symbols used later are defined as following:

KPi: the ith group of the key words;

n_{c}: seed number, the numbers of the groups;

v: dimension of the key words;

nⱼ: the number of the data in the jth dimension;

nᵢⱼ: the number of the data in the jth dimension in the ith group;

SS_{w}: the number of the data after the summation of the square values of the data points in the technology group;

SS_{b}: the number of the data after the summation of the square values of the data points between the technology group;

SSₜ: the number of the data after the summation of the square values of the total data points;

n: the number of the key words in certain technology classification; and

N: total number of the key words.

RMSSTD and RS can be expressed by the following equations respectively:

$$RMSSTD = [ \frac{{\sum }_{{i = 1 … nc}_{j = 1 … v }}^{} {\sum }_{k = 1}^{{n}_{ij}} {( {x}_{k} - {\overline{x}}_{k} )}^{2}}{{\sum }_{{i = 1 … nc}_{j = 1 … v }}^{} ( {n}_{ij} - 1 )} ]$$

$$\begin{matrix}RS = \frac{{SS}_{b}}{{SS}_{t}} \\ = \frac{{SS}_{t} - {SS}_{w}}{{SS}_{t}} \\ = \frac{\{ {\sum }_{j = 1 … v} [ {\sum }_{k = 1}^{{n}_{j}} {( {x}_{k} - {\overline{x}}_{k} )}^{2} ] \} - \{ {\sum }_{{i = 1 … c}_{j = 1 … v}} [ {\sum }_{k = 1}^{{n}_{ij}} {( {x}_{k} - {\overline{x}}_{k} )}^{2} ] \}}{{\sum }_{j = 1 … v}^{} [ {\sum }_{k = 1}^{{n}_{j}} {( {x}_{k} - {\overline{x}}_{k} )}^{2} ]}\end{matrix}$$

Since the objective of the result of the classification is to obtain the technology groups with highly similarity between each other, the lesser the variation represented by RMSSTD between the groups is, the better the result is. But, the greater the variation represented by RS between the groups is, the better the result is. After comparing these two values with each other, the results of grouping the N numbers of key words into one group to into N numbers of groups respectively can be examined to obtain the best grouping result. This grouping result can be also used to analyze the technology maturity (step S211 in FIG. 2).

As shown in FIG. 2, step S211 denotes the technology maturity analysis. For each classified technology group, the appearance frequencies of the key words and the technologies in the technology group can be calculated. In the present invention, the number of the documents mentioning the same technology denotes the maturity of the technology. The analysis of the technology maturity i can be expressed by the following equation:

$$i = \frac{( {\sum }_{j = 1}^{n} {N}_{ij} )}{M \times N} ,$$

wherein n denotes total number of the electronic documents, Nᵢⱼ denotes the number of the electronic documents belonging to the ith technology group and N denotes the number of the technology groups.

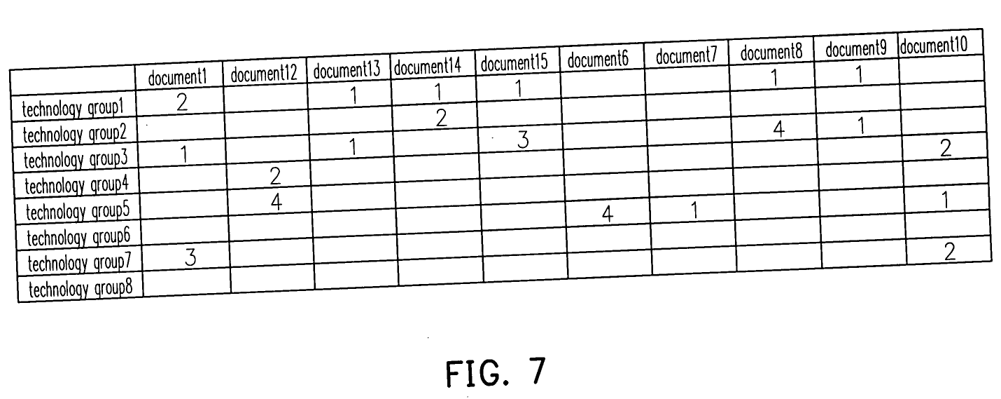

In the step S207, according to the classified technology groups obtained from the step S205, a statistic calculation is operated to statistically calculate the technologies and the key words appearance in the documents so as to establish a technology group statistic table shown in FIG. 7. As shown in FIG. 7, each technology group in the technology group statistic table is took as a dimension so that there are N dimensions for N numbers of technology groups. For N numbers of technology groups, each document can be represented as a data point with a coordinate having N elements denoted by the statistic number shown in the technology group statistic table. Therefore, each document can be point out in the N dimensional Cartesian coordinate system as a data point with a N dimension coordinate. Hence, the coordinate of each document can be used as an input value in the classification and the analysis of K-Mean algorithm. Furthermore, by using K-Means algorithm, the documents in the document folder can be grouped into several document groups. In the step S209, the classification is finished so that when performing a technology searching process, the user will also obtain other documents under the same technology group at the time the directly relative documents are found. Therefore, the technology analyzing and the searching operating become more efficient. Moreover, under no pre-classification situation or in the circumstance of further analyzing highly similar documents in the same class, searching certain technology or key words can result in retrieving other highly analogue documents.

Altogether, the method for analyzing and classifying electronic documents of the present invention comprises the steps of retrieving the key words in the documents and then statistically calculating and merging the appearance frequencies of the key words. Further, the correlations between key words are established and then the key words are grouped into several technology group mentioned in the electronic documents. Each technology group is the key word included in the technology so that each technology group can be the classification basis for means for performing the classification of the documents and the usage frequency and the detail level of the classification are increased. Moreover, under no pre-classification situation or in the circumstance of further analyzing highly similar documents in the same class, the user can easily use the technology groups and key words to search certain documents and then can also retrieve other documents highly analogue technology content. Accordingly, the accuracy of the automatically analyzing and classifying technology is improved and the searching efficiency is increased.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A method for analyzing and classifying electronic documents, comprising:
fetching an electronic document from an electronic document folder, wherein the electronic document comprises a plurality of key words;
retrieving the key words;
calculating a correlation between each two key words according to an appearance frequency of each key word; and
classifying the key words into at least one technology group according to the correlations between the key words.

2. The method of claim 1, wherein the step of retrieving the key words include at least one step selected form a group composed of word section analyzing, rhetoric analyzing, vocabulary comparison, word frequency maintaining, retrieving the key word of the candidate word library and retrieving the key word of the word library waiting for confirmation.

3. The method of claim 1, wherein the step of calculating the correlation between each two key words according to the appearance frequency of each key word comprises steps of:
de-duplicating the identical key words with merging the appearance frequencies thereof; and
calculating the correlation of each two key words.

4. The method of claim 3, wherein the step of de-duplicating the identical key words with merging the appearance frequencies thereof comprises steps of:
retrieving the key words from the electronic document;
merging the duplicated key words; and
re-calculating the appearance frequencies of the key words.

5. The method of claim 3, wherein the step of re-calculating the correlation of each two key words comprises steps of:
obtaining the appearance frequency of each key word; and
calculating a correlation coefficient between each two key words, wherein the correlation coefficient between each two key word denotes the correlation between the appearance frequencies of the key words.

6. The method of claim 1, wherein the step of classifying the key words comprises steps of:
forming a vocabulary data by using the correlations and a Cartesian dimension system with a dimension corresponding to the number of the key words, wherein each key word is represented by a data point with a coordinate composed by the correlation coefficients; and
grouping the data points in the vocabulary data into at least one technology group by using K-Means algorithm.

7. The method of claim 1, further comprises a step of obtaining a maturity of a technology group by using the number of the key words, the number of the electronic documents in the technology group and the number of the key words in the technology group.

8. A method for analyzing and classifying electronic documents, comprising:
fetching a plurality of documents from a document folder, wherein at least one of the electronic documents includes at leas a technology group;
obtaining the technology groups in the electronic documents;
statically calculating an appearance frequency of each technology group in the electronic documents; and
classifying the electronic documents into at least one document group according to the appearance frequency of each technology group in the electronic documents.

9. The method of claim 8, wherein the step of obtaining the technology groups in the electronic documents comprises steps of:
retrieving a plurality of key words in the electronic documents;
calculating a correlation between each two key words according to an appearance frequency of each key word; and
classifying the key words into at least one technology group according to the correlations between the key words.

10. The method of claim 9, wherein the step of retrieving the key words include at least one step selected form a group composed of word section analyzing, rhetoric analyzing, vocabulary comparison, word frequency maintaining, retrieving the key word of the candidate word library and retrieving the key word of the word library waiting for confirmation.

11. The method of claim 9, wherein the step of calculating the correlation between each two key words according to the appearance frequency of each key word comprises steps of:
de-duplicating the identical key words with merging the appearance frequencies thereof; and
calculating the correlation of each two key words.

12. The method of claim 11, wherein the step of de-duplicating the identical key words with merging the appearance frequencies thereof comprises steps of:
retrieving the key words from the electronic documents;
merging the duplicated key words; and
re-calculating the appearance frequencies of the key words.

13. The method of claim 11, wherein the step of re-calculating the correlation of each two key words comprises steps of:
obtaining the appearance frequency of each key word; and
calculating a correlation coefficient between each two key words, wherein the correlation coefficient between each two key word denotes the correlation between the appearance frequencies of the key words.

14. The method of claim 9, wherein the step of classifying the key words comprises steps of:
forming a vocabulary data by using the correlations and a Cartesian dimension system with a dimension corresponding to the number of the key words, wherein each key word is represented by a data point with a coordinate composed by the correlation coefficients; and
grouping the data points in the vocabulary data into at least one technology group by using K-Means algorithm.

15. The method of claim 8, wherein the step of classifying the electronic documents comprises steps of:
forming a technology data by using the appearance frequency of each technology group and a Cartesian dimension system with a dimension corresponding to the number of the technology groups, wherein each technology group is represented by a data point with a coordinate composed by the appearance number of each technology group; and
grouping the data points in the technology data into at least one document group by using K-Means algorithm.
